(19) United States
(12) Patent Application Publication
(10) Pub. No.: US 2018/0103032 A1
(43) Pub. Date: Apr. 12, 2018

(54) Authorization of Computing Devices Using Cryptographic Action Tokens

(71) Applicant: FMR LLC, Boston, MA (US)

(72) Inventors: Robert C. Bisantz, Apex, NC (US); Ashish Desai, Ashland, MA (US); James A. Grundner, Cary, NC (US)

(21) Appl. No.: 15/287,495

(22) Filed: Oct. 6, 2016

(51) Int. Cl. H04L 29/06

(52) U.S. Cl. CPC H04L 63/0807; H04L 63/0823

(57) ABSTRACT

Methods and apparatuses are described for authorization of computing devices using cryptographic action tokens. Delegation request data, including an identification certificate, an identifier for a second computing device, and action constraints, are received by a delegation system from a first computing device. A cryptographic action token, including the identifier for the second computing device and the action constraints, is generated by the delegation system. The cryptographic action token is transmitted to the second computing device. An action request specifying an action, the cryptographic action token, and an identification certificate is received by a transaction server. Action data based on the action request and the action constraints are determined by the transaction server. A determination that the action data satisfies the one or more action constraints in the cryptographic action token is made by the transaction server. The action is completed by the transaction server.

### TECHNICAL FIELD

This application relates generally to methods and apparatuses, including computer readable media, for authorization of computing devices in networked systems, and more specifically to authorization of computing devices using cryptographic action tokens for action authorization.

### BACKGROUND

Computer networks can include numerous computing devices communicating with each other. In such networks, it can be necessary to determine which computing devices are authorized to perform which actions or request the performance of such actions. Present computing network systems typically utilize a central server to provide information on the authorizations for each computing device. However, such systems can require that each computing device communicate with the central server in order to determine if another computing device is authorized to perform an action or request the action's performance. As such, these systems can lack the flexibility to allow individual computing devices to determine whether another computing device is authorized to perform an action or request the action's performance without the computing device having to communicate with the central server.

### SUMMARY

Accordingly, there is a need for systems and methods for determining a computing device's authorization in a more flexible, distributed manner. By utilizing cryptographic action tokens, the present technology can provide delegation of authority by a computing device to another computing device. Beneficially, the use of the cryptographic action tokens can facilitate a computing device in determining whether another computing device is authorized to perform an action or request the action's performance. In one aspect, there is a method. The method includes receiving, by a delegation system, from a first computing device, delegation request data including a first identification certificate identifying the first computing device, an identifier for a second computing device, and one or more action constraints. The method includes authenticating, by the delegation system, the first computing device based on at least the first identification certificate. The method includes determining, by the delegation system, the first computing device is authorized to delegate as specified in the one or more action constraints. The method includes generating, by the delegation system, a cryptographic action token including he identifier for the second computing device and the action constraints. The method includes authenticating, by the delegation system, the second computing device based on at least a second identification certificate identifying the second computing device. The method includes transmitting, by the delegation system, to the second computing device, the cryptographic action token. The method includes receiving, by a transaction server, from the second computing device, an action request specifying an action for the transaction server to execute, the cryptographic action token, and the second identification certificate. The method includes authenticating, by the transaction server, the second computing device based on at least the second identification certificate. The method includes authenticating, by the transaction server, the cryptographic action token. The method includes determining, by the transaction server, action data based on the action request and the one or more action constraints in the cryptographic action token. The method includes determining, by the transaction server, the action data satisfies the one or more action constraints in the cryptographic action token. The method includes completing, by the transaction server, the transaction the action.

In some embodiments, the second computing device is a mobile device. In some embodiments, the action constraints include one or more of one or more reuse constraints, one or more transaction type constraints, one or more time constraints, one or more location constraints, one or more transaction amount constraints, and one or more authentication constraints. In some embodiments, the action data include one or more of the action specified in the action request, a time of the action request, a location of the second computing device when providing the action request, a transaction amount associated with the action, and authentication data provided by the second computing device.

In another aspect, there is a computer system. The computer system includes a first computing device storing a first identification certificate. The computer system includes a second computing device storing a second identification certificate. The computer system includes a delegation system in data communication with the first computing device and the second computing device, the delegation system configured to: receive, from the first computing device, delegation request data including the first identification certificate, an identifier for the second computing device, and one or more action constraints; authenticate the first computing device based on at least the first identification certificate; determine the first computing device is authorized to delegate as specified in the one or more action constraints; generate a cryptographic action token including the identifier for the second computing device and the action constraints; authenticate the second computing device based on at least the second identification certificate; and transmit, to the second computing device, the cryptographic action token. The computer system includes a transaction server in data communication with the second computing device configured to: receive, from the second computing device, an action request specifying an action for the transaction server to execute, the cryptographic action token, and the second identification certificate; authenticate the second computing device based on at least the second identification certificate; authenticate the cryptographic action token; determine action data based on the action request and the one or more action constraints in the cryptographic action token; determine the action data satisfies the one or more action constraints in the cryptographic action token; and complete the transaction the action.

In some embodiments, the second computing device is a mobile device. In some embodiments, the action constraints include one or more of one or more reuse constraints, one or more transaction type constraints, one or more time constraints, one or more location constraints, one or more transaction amount constraints, and one or more authentication constraints. In some embodiments, the action data include one or more of the action specified in the action request, a time of the action request, a location of the computing device when providing the action request, a transaction amount associated with the action, and authentication data provided by the second computing device.

In another aspect, there is a non-transitory computer readable storage medium including programmatic instructions for operation of a computing environment. The instructions are operable to cause a delegation system in data communication with a first computing device and a second computing device to: receive, from the first computing device, delegation request data including a first identification certificate, an identifier for the second computing device, and one or more action constraints; authenticate the first computing device based on at least the first identification certificate; determine the first computing device is authorized to delegate as specified in the one or more action constraints; generate cryptographic action token including the identifier for the second computing device and the action constraints; authenticate the second computing device based on at least a second identification certificate; and transmit, to the second computing device, the cryptographic action token. The instructions are operable to cause a transaction server in data communication with the second computing device to: receive, from the second computing device, an action request specifying an action for the transaction server to execute, the cryptographic action token, and the second identification certificate; authenticate the second computing device based on at least the second identification certificate; authenticate the cryptographic action token; determine action data based on the action request and the one or more action constraints in the cryptographic action token; determine the action data satisfies the one or more action constraints in the cryptographic action token; and complete the transaction the action.

In some embodiments, the second computing device is a mobile device. In some embodiments, the action constraints include one or more of one or more reuse constraints, one or more transaction type constraints, one or more time constraints, one or more location constraints, one or more transaction amount constraints, and one or more authentication constraints. In some embodiments, the action data include one or more of the action specified in the action request, a time of the action request, a location of the computing device when providing the action request, a transaction amount associated with the action, and authentication data provided by the second computing device.

Other aspects and advantages of the technology will become apparent from the following detailed description, taken in conjunction with the accompanying drawings, illustrating the principles of the technology by way of example only.

### BRIEF DESCRIPTION OF THE DRAWINGS

The advantages of the technology described above, together with further advantages, may be better understood by referring to the following description taken in conjunction with the accompanying drawings. The drawings are not necessarily to scale, emphasis instead generally being placed upon illustrating the principles of the technology.

FIG. 1 depicts a networked computing system in accordance with embodiments of the technology.

FIG. 2 is a flow diagram illustrating generation and provision of a cryptographic action token.

FIG. 3 is a flow diagram illustrating use of a cryptographic action token to initiate an action.

### DETAILED DESCRIPTION

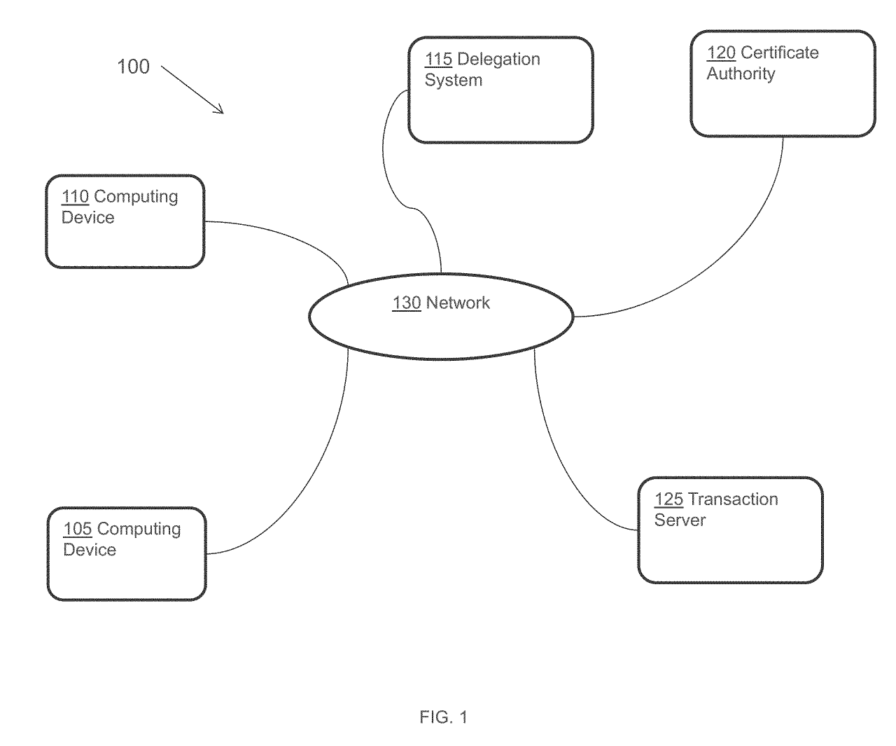

FIG. 1 depicts networked computing system 100 in accordance with embodiments of the technology. System 100 includes computing device 105, computing device 110, delegation system 115, certificate authority 120, transaction server 125, and communications network 130. In an exemplary application of the technology, computing device 105 can send a delegation request to delegation system 115, via network 130, to delegate authorization to computing device 110. Delegation system 115 can generate a cryptographic action token for computing device 110, specifying for computing device 110 authorization for an action. Computing device 110 can then receive the cryptographic action token from delegation system 115. Computing device 110 can provide the cryptographic action token to transaction server 125 to perform the action. Transaction server 125 can determine that computing device 110 is authorized for the action based on the cryptographic action token and complete the action. Beneficially, in some embodiments, transaction server 125 does not need to communicate with delegation system 115 to verify that computing device 110 is authorized for the action.

Computing device 105 can be, for example, a desktop computer, laptop computer, tablet, mobile device, smartphone, or other networked device. Computing device 110 can be, for example, a desktop computer, laptop computer, tablet, mobile device, smartphone, or other networked device. It should be appreciated that other types of computing devices that are capable of connecting to the components of system 100 can be used without departing from the scope of technology. Although FIG. 1 depicts two computing devices, computing device 105 and computing device 110, a networked computing system including any number of computing devices is contemplated.

Certificate authority 120 can be a combination of hardware, including one or more processors and one or more physical memory modules, and specialized software engines that execute on the processors of certificate authority 120. Certificate authority 120 can be a trusted certificate authority, as is well known in computer networking. In some embodiments, computing device 105, computing device 110, delegation system 115, and/or transaction server 125 can communicate with certificate authority 120 to facilitate authenticating another component of system 100. For example, certificate authority 120 can facilitate authentication between the components of system 100 by facilitating verification of a certificate presented by one component of system 100 to another.

Delegation system 115 can be a combination of hardware, including one or more processors and one or more physical memory modules, and specialized software engines that execute on the processors of delegation system 115 to receive data from other components of the system 100, transmit data to other components of the system 100, and generate and/or provide cryptographic action tokens.

Network 130 can be a local network, such as a LAN, a wide area network, such as the Internet and/or a cellular network, or several discrete networks and/or sub-networks (e.g., cellular to Internet, point to point, ad hoc, etc.) that enable the components of system 100 to communicate with each other. For example, computing device 105 and computing device 110 can communicate with delegation system 115 via a cellular network and/or the Internet to initiate generation of and/or receive a cryptographic action token. As a further example; computing device 105 and computing device 110 can communicate with transaction server via a Bluetooth, Near-Field Communication (“NFC”), or ad-hoc WiFi connection.

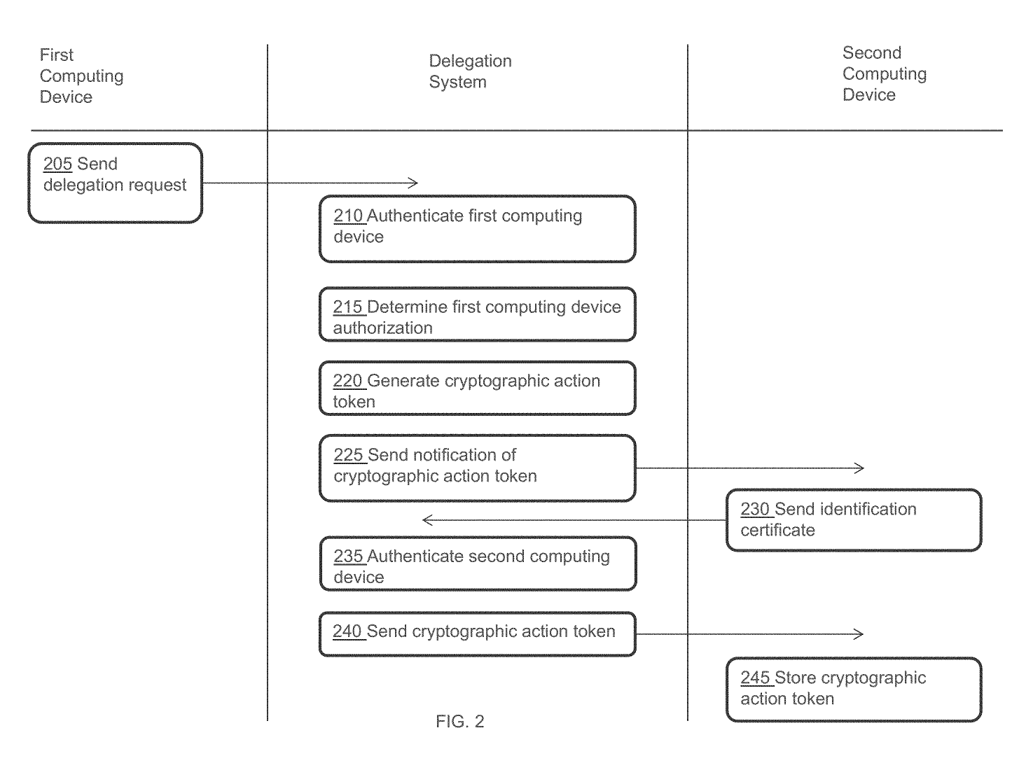

FIG. 2 is a flow diagram illustrating generation and provision of a cryptographic action token. At step 205, a first computing device (e.g., computing device 105) sends a delegation request to a delegation system delegation system 115). The delegation request can include a certificate identifying the first computing device. For example, the certificate can be a public key certificate assigned to the first computing device by a certificate authority (e.g., certificate authority 120). The certificate can, for example, provide the first computing device's public key and can be cryptographically signed by the certificate authority. The delegation request can include an identifier for a second computing device (e.g., computing device 110). For example, the identifier can be a username, email address, or other identifier that is associated with the second computing device.

The delegation request can include one or more action constraints. Generally, action constraints specify the characteristics of the action, providing the scope of the authorization the first computing device is delegating to the second computing device. In some embodiments, an action constraint can specify the action's type. An action constraint can specify quantities associated with the action, such as transaction amounts. An action constraint can specify the time frame in which the second computing device can request the action be performed. An action constraint can specify whether the second computing device is authorized to request a single action or multiple actions. An action constraint can specify a geographical limitation, such as limiting the second device's authorization to a specific city or state. An action constraint can specify the kind of authentication required from the second computing device before the action can be completed.

As an example, the action constraints for a delegation request can specify that the second computing device is authorized to access certain data stored on a computer system. The exemplary action constraints can specify whether the second computing device is authorized to view or modify the data. The exemplary action constraints can further specify the file names or database tables or records containing the data. The exemplary action constraints can further specify the second computing device is authorized to access the data during a specific week.

As another example, the action constraints for a delegation request can specify that the second computing device is authorized to request purchase of 100 shares of a particular company's stock. The exemplary action constraints can further specify the brokerage account from which the price for shares can be withdrawn. The exemplary action constraints can further specify that the trade is authorized to be performed on a specific date.

As another example, the action constraints for a delegation request can specify that the second computing device is authorized to request purchase of up to 100 shares of a particular company's stock at a price between $25 and $35 per share. The exemplary action constraints can further specify the brokerage account from which the price for the shares can be withdrawn. The exemplary action constraints can further specify that the trade is authorized to be performed during a specific date range. The exemplary action constraints can further specify the second computing device is authorized to perform the trades in more than one transaction.

As the above examples illustrate, in some instances the action constraints can fully specify the action that the second computing device is authorized to perform by specifying all aspects of the action. In some instances, the action constraints may not fully specify the action that the second computing device is authorized perform, permitting the second computing device to control some aspects of the action, provided all action constraints are satisfied.

This disclosure makes use of the following notations in describing cryptographic aspects of the technology:
PrK_{CD1} is the first computing device's private key;
PubK_{CD2} is the first computing device's public key;
PrK_{CD2} is the second computing device's private key;
PubK_{CD2} is the second commuting device's public key;
PrK_{D} is the delegation system's private key;
PubK_{D} is the delegation system's public key;
PrK_{T} is the transaction server's private key;
PubK_{T} is the transaction server's public key;
S-K [. . . ] indicates the data in the brackets is cryptographically signed using the key K;
E-K [. . . ] indicates the data in the brackets is encrypted using the key K;

In accordance with embodiments of the technology, the first computing device can cryptographically sign the identifier for the second computing device and the action constraints in the delegation request. For example, the identifier for the second computing device and the action constraints can be signed with the first computing device's private key, as follows:
S-PrK_{CD1}[identifier of second computing device+action constraints]

At step 210, the delegation system can authenticate the first computing device. For example, the delegation system can authenticate the first computing device using the first computing device's certificate provided in the delegation request. The delegation system can then use the first computing device's public key, S-PubK_{CD1}, to verify the first computing device's signature on the delegation request. At step 215, the delegation system can determine whether the first computing device is authorized to delegate authorization to the second computing device for the action specified by the action constraints. For example, if the action constraints would give the second computing device authorization to view certain data, the delegation server can determine whether the first computing device is authorized to the view the data and whether the first computing device is authorized to delegate authorization for such access. As another example, if the action constraints would give the second computing device authorization to conduct a stock trade for a particular brokerage account, the delegation server can determine whether the first computing device is authorized to use that brokerage account and whether the first computing device is authorized to delegate authorization for such use. If the first computing device is not authorized, the delegation system can send a message to the first computing device indicating the delegation request was denied.

If the first computing device is authorized, the delegation system can generate a cryptographic action token at step 220. In some embodiments, the cryptographic action token can take the following form:
S-PrK_{D}[S-Prk_{CD1}[identifier of second computing device+action constraints]]
   As shown, the cryptographic action token includes S-PrK_{CD1}[identifier of second computing device+action constraints]] signed by the delegation system's private key, PrK_{D}.

At step 225, the delegation system can send a notification of the cryptographic action token to the second computing device. In some embodiments, the delegation server can send a push notification to the second computing device. In response to the notification, the second computing device can send a request for the cryptographic action token to the delegation system. The request from the second computing device can include a certificate identifying the second computing device. For example, the certificate can be a public key certificate assigned to the second computing device by a certificate authority. The certificate can, for example, provide the second computing device's public key and can be cryptographically signed by the certificate authority. At step 235, the delegation system can authenticate the second computing device. For example, the delegation system can authenticate the second computing device using the second computing device's certificate provided in the request for the cryptographic action token.

At step 240, the delegation system can send the cryptographic action token to the second computing device. The delegation system can protect the token as shown below:
S-PrK_{D}[E-PubK_{C2}[E-PubK_{T}[S-PrK_{D}[S-PrK_{CD1} [identifier of second computing device+action constraints]]]]]
   The second computing device can use PubK_{D} to validate the delegation system's signature. The second computing device can then use PrK_{C2} to decrypt E-PubK_{C2}[E-PubK_{T}[S-PrK_{D}[S-PrK_{CD1} [identifier of second computing device+action constraints]]]], resulting in E-PubK_{T}[S-PrK_{D}[S-PrK_{CD1} [identifier of second computing device+action constraints]]]. In some embodiments, the action constraints can be provided to the second computing device in manner readable by the second computing device to allow the second computing device to determine the action constraints contained in the cryptographic action token. At step 245, the second computing device can store the cryptographic action token.

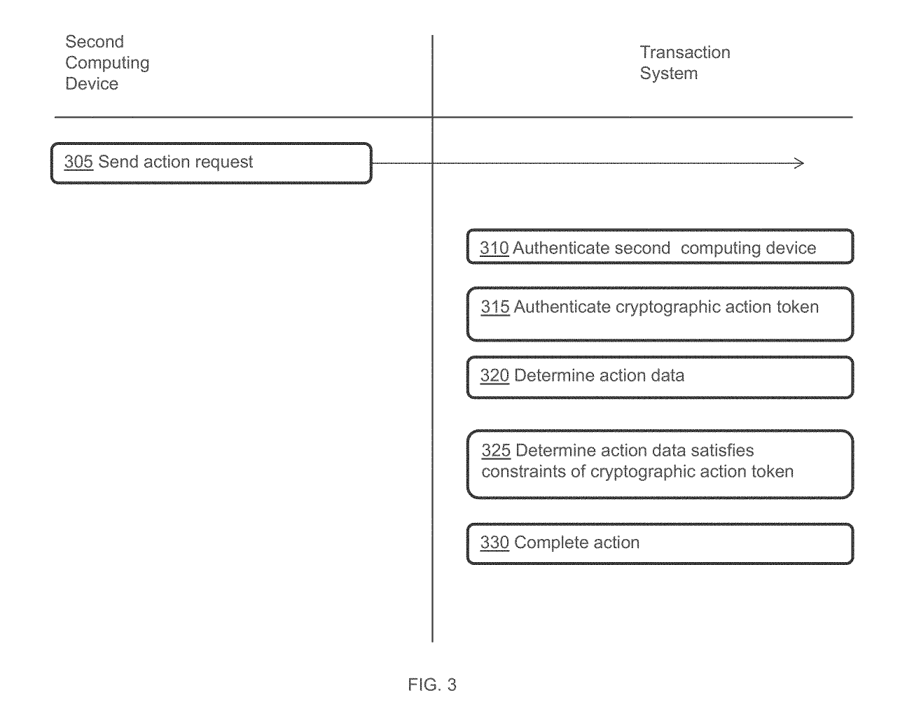

FIG. 3 is a flow diagram illustrating use of a cryptographic action token to initiate an action. At step 305, the second computing device transmits an action request, a cryptographic action token, and a certificate to the transaction server (e.g., transaction server 125). The action request can include information specifying the requested action. For example, the action request can include a request to access a specified file. As another example, the action request can include a request to purchase a specified amount of a company's stock using a specified brokerage account. Along with the action request, the second computing device can send a certificate identifying the second computing device. For example, the certificate can be a public key certificate assigned to the second computing device by a certificate authority. The certificate can, for example, provide the second computing device's public key and can be cryptographically signed by the certificate authority.

The second computing device can sign the cryptographic action token and send it to the transaction server in the following form:
S-PrK_{CD2}[E-PubK_{T}[S-PrK_{D}[S-PrK_{CD1} [identifier of second computing device+action constraints]]]]

At step 310, the transaction server can authenticate the second computing device. For example, the transaction server can authenticate the second computing device using the second computing device's certificate provided in the action request. At step 315, the transaction server can authenticate the cryptographic action token. For example, the transaction servers can receive the cryptographic action token in the following form:
S-PrK_{CD2}[E-PubK_{T}[S-PrK_{D}[S-PrK_{CD1} [identifier of second computing device+action constraints]]]]The transaction server can use PrK_{CD2} to verify the second computing device's signature. The transaction server can then use PrK_{T} to decrypt E-PubK_{T}[S-PrK_{D}[S-PrK_{CD1} [identifier of second computing device+action constraints]]], resulting in S-PrK_{D}[S-PrK_{CD1} [identifier of second computing device+action constraints]]. The transaction server can then use S-PubK_{D} to verify the delegation server's signature, verifying for the transaction server that the identifier of the second computing device and the action constraints have not been tampered with. The transaction server can then use S-PrK_{CD1} to verify the first computing device's signature on the identifier of second computing device and the action constraints.

At step 320, the transaction can determine the action data from the action request (e.g., the details of the requested action). At step 325, the transaction server can determine whether the action satisfies the action constraints. The transaction server can compare the action data to the constraints obtained from the cryptographic action token to confirm the requested action complies with the constraints. For example, if the action data indicates the requested action is accessing a specified file, the transaction server can verify that the action constraints permit accessing the specified file. As noted above, in some instances, the action constraints can fully specify the authorized action. In such instances, the transaction server can determine the action data from the action constraints in the cryptographic action token. If the action data satisfies the action constraints, the transaction server can complete the transaction.

Method steps can be performed by one or more special-purpose processors executing a computer program to perform functions of the technology by operating on input data and/or generating output data. Method steps can also be performed by, and an apparatus can be implemented as, special-purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special-purpose microprocessors. Generally, a processor receives instructions and data from a read-only memory or a random access memory or both. The essential elements of a computer are a specialized processor for executing instructions and one or more specifically-allocated memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

1. A method of authorization of computing devices using cryptographic action tokens, the method comprising:
a. receiving, by a delegation system, from a first computing device, delegation request data comprising a first identification certificate identifying the first computing device, an identifier for a second computing device, and action constraints comprising: one or more transaction type constraints, one or more action request timeframe constraints, one or more location constraints, one or more transaction amount constraints, one or more reuse constraints, and one or more authentication type constraints;
b. authenticating, by the delegation system, the first computing device based on at least the first identification certificate;
c. determining, by the delegation system, the first computing device is authorized to delegate as specified in the action constraints;
d. generating, by the delegation system, a cryptographic action token comprising the identifier for the second computing device and the action constraints;
e. authenticating, by the delegation system, the second computing device based on at least a second identification certificate identifying the second computing device;
f. transmitting, by the delegation system, to the second computing device, the cryptographic action token;
g. receiving, by a transaction server computing device, from the second computing device, an action request specifying an action for the transaction server computing device to execute, the cryptographic action token, and the second identification certificate;
h. authenticating, by the transaction server computing device, the second computing device based on at least the second identification certificate;
i. authenticating, by the transaction server computing device, the cryptographic action token;
j. determining, by the transaction server computing device, action data based on the action request and the action constraints in the cryptographic action token;
k. determining, by the transaction server computing device, the action data satisfies the action constraints in the cryptographic action token; and
l. completing, by the transaction server computing device, the action.

2. The method of claim 1, wherein the second computing device is a mobile device.

3. (canceled)

4. The method of claim 1, wherein the action data comprise: the action specified in the action request, a time of the action request, a location of the second computing device when providing the action request, a transaction amount associated with the action, and authentication data provided by the second computing device.

5. A computer system for authorization of computing devices using cryptographic action tokens, the computer system comprising:
a. a first computing device storing a first identification certificate;
b. a second computing device storing a second identification certificate;
c. a delegation computing device in data communication with the first computing device and the second computing device that:
i. receives, from the first computing device, delegation request data comprising the first identification certificate, an identifier for the second computing device, and action constraints comprising: one or more transaction type constraints, one or more action request timeframe constraints, one or more location constraints, one or more transaction amount constraints, one or more reuse constraints, and one or more authentication type constraints;
ii. authenticates the first computing device based on at least the first identification certificate;
iii. determines the first computing device is authorized to delegate as specified in the action constraints;
iv. generates a cryptographic action token comprising the identifier for the second computing device and the action constraints;
v. authenticates the second computing device based on at least the second identification certificate; and
vi. transmits, to the second computing device, the cryptographic action token;
d. a transaction server computing device in data communication with the second computing device that:
i. receives, from the second computing device, an action request specifying an action for the transaction server computing device to execute, the cryptographic action token, and the second identification certificate;
ii. authenticates the second computing device based on at least the second identification certificate;
iii. authenticates the cryptographic action token;
iv. determines action data based on the action request and the action constraints in the cryptographic action token;
v. determines the action data satisfies the action constraints in the cryptographic action token; and
vi. completes the action.

6. The computer system of claim 5, wherein the second computing device is a mobile device.

7. (canceled)

8. The computer system of claim 5, wherein the action data comprise: the action specified in the action request, a time of the action request, a location of the second computing device when providing the action request, a transaction amount associated with the action, and authentication data provided by the second computing device.

9. A non-transitory computer readable storage medium comprising programmatic instructions for authorization of computing devices using cryptographic action tokens, the instructions, when executed, cause:
a. a delegation computing device in data communication with a first computing device and a second computing device to:
i. receive, from the first computing device, delegation request data comprising a first identification certificate, an identifier for the second computing device, and action constraints comprising: one or more transaction type constraints, one or more action request timeframe constraints, one or more location constraints, one or more transaction amount constraints, one or more reuse constraints, and one or more authentication type constraints;
ii. authenticate the first computing device based on at least the first identification certificate;
iii. determine the first computing device is authorized to delegate as specified in the action constraints;
iv. generate a cryptographic action token comprising the identifier for the second computing device and the action constraints;
v. authenticate the second computing device based on at least a second identification certificate; and
vi. transmit, to the second computing device, the cryptographic action token;
b. a transaction server computing device in data communication with the second computing device to:
i. receive, from the second computing device, an action request specifying an action for the transaction server computing device to execute, the cryptographic action token, and the second identification certificate;
ii. authenticate the second computing device based on at least the second identification certificate;
iii. authenticate the cryptographic action token;
iv. determine action data based on the action request and the action constraints in the cryptographic action token;
v. determine the action data satisfies the action constraints in the cryptographic action token; and
vi. complete the action.

10. The non-transitory computer readable storage medium of claim 9, wherein the second computing device is a mobile device.

11. (canceled)

12. The non-transitory computer readable storage medium of claim 9, wherein the action data comprise: the action specified in the action request, a time of the action request, a location of the second computing device when providing the action request, a transaction amount associated with the action, and authentication data provided by the second computing device.
